(19) United States
(12) Patent Application Publication
(10) Pub. No.: US 2012/0016940 A1
(43) Pub. Date: Jan. 19, 2012

(54) Geographic Based Logical Message Addressing And Delivery

(75) Inventor: Robert Hall, Berkeley Heig, NJ (US)

(73) Assignee: AT&T Intellectual Property I LP, Reno, NV (US)

(21) Appl. No.: 12/837,168

(22) Filed: Jul. 15, 2010

(51) Int. Cl. G06F 15/16

(52) U.S. Cl. 709/206; 709/245

(57) ABSTRACT

A geographic addressing scheme is used to route a message from a sender to all devices occupying a specified geographic region. Message delivery and addressing are based on logical predicates being satisfied, wherein the logical predicates comprise a geographic region and at least one filter predicate. When a message is received by a device, the logical predicate is evaluated to determine if the requirements of the logical predicate are satisfied. In one configuration, a Boolean value (true or false) if determined. If the Boolean result is true, the message is provided to an appropriate application, or applications, residing on the device. If the Boolean result is false, the message is ignored silently.

### TECHNICAL FIELD

The technical field generally relates to message addressing and delivery, and more specifically to addressing and delivering messages where delivery is geographically constrained.

### BACKGROUND

Imagine a situation in which a message is to be sent to recipients meeting certain criteria and the recipients are widely dispersed, geographically. For example, consider sending a message to alert all users of handheld devices currently running low on battery charge that they may wish to buy ABC Company's portable battery charger. Or, consider sending a message to all TSA (Transportation Security Administration) employees located at specific airports. Potential recipients could be scattered across the entire planet. Sending a message to everyone simply is not practicable. And, attempting to implement an infrastructure to track and maintain status of everyone also is not practicable.

### SUMMARY

Message delivery and addressing are based on a physical location (or locations) of an intended recipient and are based on at least one additional condition being met. That is, message delivery and addressing are based on logical predicates being satisfied, wherein the logical predicates comprise a geographic region and at least one other filter predicate. More specifically, in an example embodiment, message delivery and addressing are based on components (sub-predicates) of a logical predicate being satisfied, wherein the logical predicate comprises a physical location component (e.g., physical location comprising a spatial and/or temporal sub-predicate) and at least one other component (filter sub-predicate). Messages are accepted by recipients satisfying the requirements of the logical predicate. In an example embodiment, a physical location is incorporated as part of an addressing protocol in order to route messages to intended recipients at the appropriate locations. Each recipient that receives a candidate message determines if all sub-predicates are satisfied. If so, the message is accepted and processed by the intended recipient. If not, the message is not accepted and processed by the intended recipient.

### BRIEF DESCRIPTION OF THE DRAWINGS

FIG. 1 illustrates an example mobile ad hoc network in which geographic based logical message addressing and delivery may be implemented.

FIG. 2 illustrates example communications in an ad hoc network in which geographic based logical message addressing and delivery can be implemented via a WiFi access point.

FIG. 3 illustrates an example mobile ad hoc network in which geographic based logical message addressing and delivery can be implemented utilizing tiered geocasting and forwarding zones.

FIG. 4 is a flow diagram of an example process for implementing geographic based logical message addressing and delivery.

FIG. 5 is a block diagram of an example communications device configured to implement geographic based logical message addressing and delivery.

FIG. 6 depicts an overall block diagram of an exemplary packet-based mobile cellular network environment, such as a GPRS network, within which geographic based logical message addressing and delivery can be implemented.

FIG. 7 illustrates an architecture of a typical GPRS network within which geographic based logical message addressing and delivery can be implemented.

FIG. 8 illustrates an exemplary block diagram view of a GSM/GPRS/IP multimedia network architecture within geographic based logical message addressing and delivery can be implemented.

### DETAILED DESCRIPTION OF ILLUSTRATIVE EMBODIMENTS

Geographic based logical message addressing and delivery, referred to herein as logicast, provides the capability to address and deliver logically addressed messages when the logical address includes a geographic constraint. Message delivery and addressing are based on sub-predicates of a logical predicate being satisfied, wherein the predicate comprises a physical location sub-predicate and at least one other sub-predicate. Messages are accepted and processed by recipients satisfying the requirements of the logical predicate.

In an example embodiment, logicast refers to addressing, transferring, and delivering a message via a network in a accordance with a geocast protocol wherein the address comprises a spatial and/or temporal (geographic) portion referred to as a geocast region, and a logical/symbolic portion referred to as a filter predicate. Logicast provides the ability to transfer a message, via a geocast protocol, from a sender to each member of a set of devices currently occupying the geocast region and satisfying the filter predicate.

Logicasting can provide very efficient tracking of sets of highly mobile devices satisfying various logical conditions. Example applications include enterprise alerting, secure military and first responder messaging applications, opt-in advertising, or the like. For example, in a less efficient manner, attempting to utilize a server in a network with a database that contains a list of all devices that satisfy the predicate at a given time would require constant update of the server as devices move and change state. In order to send a message, the server would be consulted to translate the device set into a list of internet-protocol (IP) addresses, and at that point, the message would be routed using traditional IP routing. This traditional solution involves the costs and inefficiencies of purchasing/leasing and maintaining the server, transmitting tracking and state update messages to the server from all devices, the added query cost of accessing the server to retrieve IP addresses, and it would only work when devices are connected to the Internet. That is, it would fail if network infrastructure were broken or non-existent as in disaster situations or in remote areas of the world. In addition, there is a very high cost in taking the resulting list of individual IP addresses and sending a separate unicast message copy to each recipient individually. Logicast, however, allows the network to propagate the message completely without need for any centralized server based on local device information.

Logicast is particularly suited to highly mobile devices without requiring connection to an infrastructure-based communications network. A mobile ad hoc network is an example of such a set of devices. Mobile ad hoc networks extend the reach of data networking into areas and scenarios in which infrastructure-based networking is impossible or impractical. For example, mobile ad hoc networks can allow first responders to use networked messaging and information applications in a zone where the network infrastructure has been destroyed by a disaster. Mobile ad hoc networks can provide military units operating in battlefield situations lacking infrastructure the same types of benefits as infrastructure-based networks. Mobile ad hoc networks can allow networking among low resource nodes, such as man-worn devices powered by lightweight wearable batteries, by allowing units to relay each other's short-range transmissions, instead of each unit transmitting long range directly to the destination. Some mobile ad hoc networks, such as military mobile ad hoc networks, require high security, due to the life-critical nature of battlefield secrecy.

To better understand logicast and applications thereof, a description of mobile ad hoc networks is provided. In is to be understood however, that applications of logicast are not limited to mobile ad hoc networks. Rather, logicast is applicable to any appropriate device or group of devices.

A mobile ad hoc network comprises communications devices (also referred to as nodes) that communicate with each other via geographical broadcasting, referred to as geocasting. Geocasting is described in U.S. Pat. No. 7,525,933, entitled “System And Method For Mobile Ad Hoc Network,” filed Nov. 30, 2005, issued Apr. 28, 2009, and is incorporated by reference herein in its entirety. Geocasting uses a protocol in which an IP address is replaced with a geographic address. Thus, each geocast message comprises an indication of a location of a geographic region of intended reception of the geocast message. Generally, a packet is sent to every communications device located within a specific geographic region. The packet can contain an indication of the location of the sender, an indication of the geographic region, a payload, or a combination thereof, or the like. The communications devices in the geographic region, and any other communications devices that can communicate with them, are referred to, collectively, as a mobile ad hoc network. No registration is required to become a member of the mobile ad hoc network. Any communications device in the mobile ad hoc network can send a message to any or every communications device in the mobile ad hoc network. As communications devices move within communications range of any member of the mobile ad hoc network, they can become members of the mobile ad hoc network without requiring registration. The communications devices of the ad hoc network of communications devices communicate with each other. The ad hoc network of communications devices does not require base station terminals to control communications between the mobile devices. In example embodiments, base stations or routers may be used to relay messages between different mobile ad hoc networks, or to use other network transports such as other traditional internet protocol networks, such as the internet, to bridge messages between mobile ad hoc networks. Each communications device is capable of receiving and/or transmitting data packets to and/or from other communications devices in the mobile ad hoc network.

In an example embodiment, a communications device transfers packets to other communications devices according to heuristic decision rules that determine whether a receiving device will re-transmit a received packet. These rules effectively guide packets to their destinations and control communication traffic within the ad hoc network. The decision rules achieve this control by using statistics obtained and recorded by a communications device as it receives packets transmitted within reception range within its environment. This distributed packet transfer mechanism results in packets “flowing” to and throughout the geocast region specified in each packet. The communications devices in the geocast region receive and process each distinct packet, typically rendering the content (e.g., payload content) to the user via a user interface of a communications device. However, it is possible that some messages, such as status monitoring messages, or the like, will not be rendered because they do not require user awareness. Two packets are distinct if they contain distinct geocast identifiers. However, a re-transmitted copy of a packet generally will contain the same geocast identifier as the original packet.

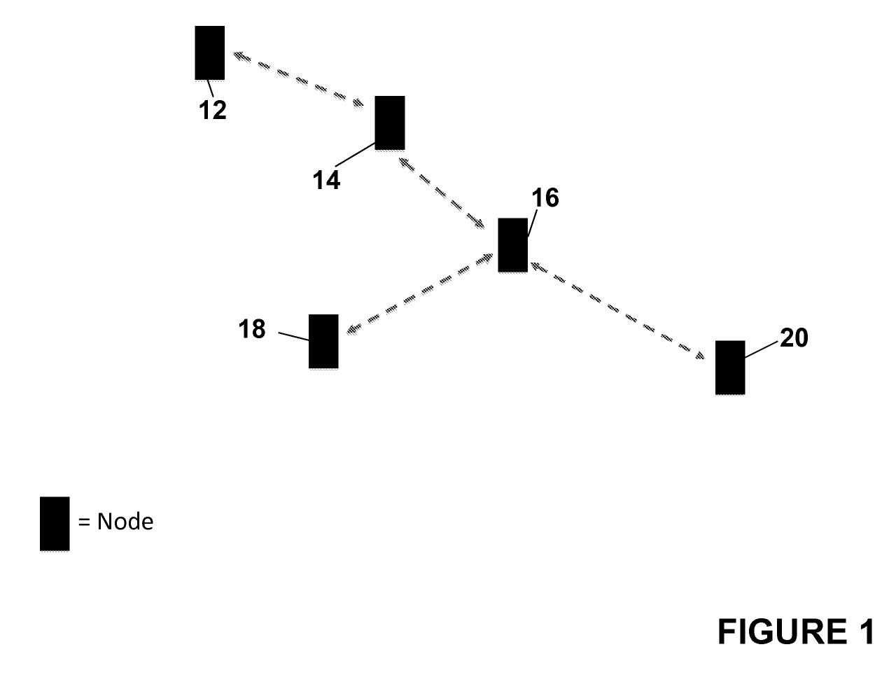

FIG. 1 illustrates an example mobile ad hoc network in which logicast may be implemented. Communications devices (nodes) in the mobile ad hoc network can communicate via RF encoded with geographic information, via Bluetooth technology, via WiFI (e.g., in accordance with the 802.11 standard), or the like, or any combination thereof. For example, as depicted in FIG. 1, communication devices 12, 14, 16, 18, and 20 form a mobile ad hoc network. As shown in FIG. 1, communication device 12 communicates with communications device 14 directly (e.g., via Bluetooth). Communication device 14 communicates with communications device 16, and thus can retransmit information received from communications device 12 to communications device 16, and vice versa (retransmit information received from communications device 16 to communications device 12). Communications device 16 communicates with communications devices 18 and 20, and can relay information from/to communications devices 18 and/or 20 to/from communications devices 12 and/or 14.

Although not depicted in FIG. 1, it is possible, in a mobile ad hoc network, that, for a pair of nodes (A and B for example), node A can receive from node B but node B can not receive from node A. This asymmetric style of communication is potential likely in a mobile ad hoc network.

In an example embodiment, communications devices that receive a message can resend the message in accordance with the scalable wireless geocast protocol. For example, a communication device's ability to retransmit a message can be based on the number of times the message was previously received, the communication device's proximity with respect to the communications devices from which the message was sent, and/or the communication device's proximity to the geocast region. This can be implemented as a three step location-based approach, which is described in detail in the aforementioned U.S. Pat. No. 7,525,933, entitled “System And Method For Mobile Ad Hoc Network,” filed Nov. 30, 2005, issued Apr. 28, 2009. First, in accordance with the location-based approach, the receiving communication device determines whether it has previously received the same message at least a predetermined number (N) of times. If not, it retransmits the message over the ad hoc network of communications devices. If so, the communications device progresses to the second step and determines whether the sending communications device is closer than some minimum distance away. If no prior transmitter of the message was closer than some minimum distance away, the communications device retransmits the message over the ad hoc network of communications devices. Otherwise, the communications device progresses to the third step and determines whether it is closer to the center of the geocast region than any sending communications device from which the message was received. If so, the communications device transmits the message over the ad hoc network of communications devices. If not, the communications device does not retransmit the message.

This location-based approach can prevent the receiving communications device from retransmitting a message that was most likely already retransmitted by another communications device located close to it (and thus most likely reaching the same neighboring communications devices that it can reach). In addition, this location-based approach reduces the chance that the communications device will retransmit the same message multiple times to the same neighboring communications devices.

As mentioned, a mobile ad hoc network does not require a communications network infrastructure or a WiFi access point. However, in an example configuration, a mobile ad hoc network can utilize WiFi access points and/or a communications network infrastructure.

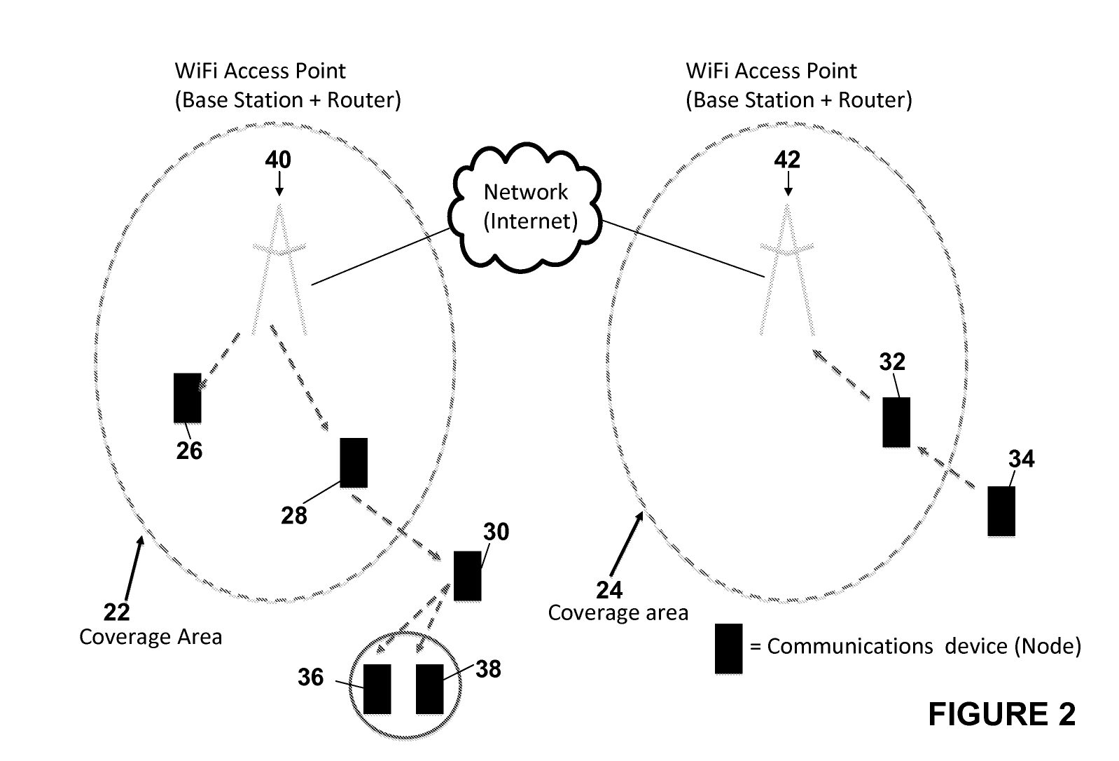

FIG. 2 illustrates example communications in an ad hoc network in which logicast can be implemented via a WiFi access point. As depicted in FIG. 2, communication devices 26, 28, 30, 36, and 38 form a mobile ad hoc network and communication device 32 and 34 form another mobile ad hoc network. Coverage area 22, which is the area covered by a WiFi access point 40, covers communication devices 26 and 28. Coverage area 24, which is the area covered by another WiFi access point 42 covers communication device 32. As shown in FIG. 2, communication device 34 transmits to communication device 32 directly (e.g., via Bluetooth). Communication device 32 retransmits to a WiFi access point 42 which in turn retransmits to the other WiFi access point 40. Communication devices 26 and 28 receive the transmission from the WiFi access point 40, and communication device 28 retransmits directly to communication device 30. And, as depicted, communication device 30 retransmits to other communication devices 36 and 38.

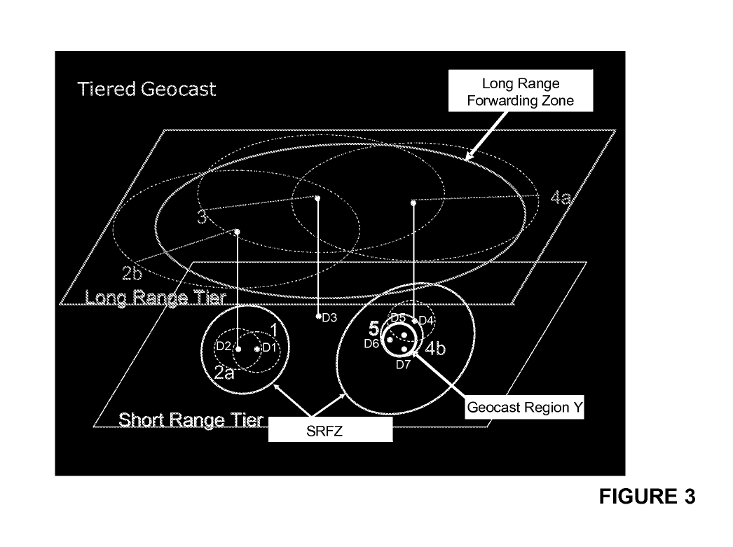

FIG. 3 illustrates an example mobile ad hoc network in which logicast can be implemented utilizing tiered geocasting and forwarding zones. Tiered geocasting uses long range (LR) transmitters (such as communications devices, etc), infrastructure, a communications network, a cellular tower, or a combination thereof, when available. Tiered geocasting assumes that at least one tier is usable by at least one of the communications devices. A long range tier is a tier wherein characteristic message transfers between devices occur over a longer physical range than those over some other tier. A long range tier can be wireless, wired, or a combination thereof.

A forwarding zone can be utilized to implement tiered geocasting. A common forwarding zone can be defined for all geocast packets or different forwarding zones can be defined for each type of geocast packet. Forwarding zones (as shown in FIG. 3, for example and without limitation) can be defined differently in different tiers, even for the same packet type or even same packet. Thus, forwarding heuristics can be applied independently per tier, with bridging at multi-tier capable nodes. In an example embodiment, a communications device retransmits a packet only if the communications device is located within the forwarding zone defined for the packet's type. This determination is in addition to the determinations described above and, if the communications device is not in the forwarding zone, the packet will not be retransmitted, even if one or more of the above conditions would otherwise have caused a retransmission hold.

As depicted in FIG. 3, nodes (e.g., communications devices) D1, D2, D3, D4, D5, D6, and D7, are at various locations within short range (SR) and long range (LR) tiers. All of devices D1, D2, D3, D4, D5, D6, and D7 together form a mobile ad hoc network, with devices D5, D6, and D7 being located in geocast region Y, hence being targets of a message sent by D1. Each communications device D1, D2, D3, D4, D5, D6, and D7 can determine its own geographical location through any type of location determination system including, for example, the Global Positioning System (GPS), assisted GPS (A-GPS), time difference of arrival calculations, configured constant location (in the case of non-moving nodes), any combination thereof, or any other appropriate means. Each communications device is operable to transmit and receive packets on a mobile ad hoc network. In addition, at any given time, some subset (possibly all) of the communications devices may be operable to transmit and receive packets over the long range tier network. For example, though not a limitation, in FIG. 3, devices D2, D3, and D4 can transmit and receive messages over both the short and long range tiers. Note that this latter fact is indicated visually in the diagram by D2, D3, and D4 each having two dots (one in the short range tier and one in the long range tier) connected by a vertical line. The long-rang tier network can be any network in which packets can be transmitted from one long range capable communications device to another long range capable communications device. Such packet networks can include, for example, an infrastructure-based network comprising wireless base stations (for up- and down-link) operating on a separate frequency from that used by an ad hoc network. In addition, the long rang tier network also could be implemented simply as another instance of an ad hoc network using distinct radio frequencies and possibly longer radio ranges.

Communications device D1 transmits the message, and communications device D2 receives the transmission from communications device D1. Communications device D2 retransmits (transmission 2a), within the short range tier and in accordance with the heuristics for the short range forwarding zone (SRFZ) as well as within the long range tier (transmission 2b). Communications D2, with long range transmission capability (in the long range tier) retransmits in the long range tier as well (transmission 2b). Communications device D3 receives the transmission 2b from communications device D2 and retransmits (as transmission 3) in the long range tier only. Communications device D4 receives the transmission 3 from communications device D3 and retransmits both on the long and short range tiers, resulting in transmission 4a in the long range tier and 4b in the short range tier. Communications device D5, within geocast region Y, receives the transmission 4a, and in turn retransmits (transmission 5) within the geocast region Y. Transmission 5 is received by the other devices in geocast region Y, namely devices D6 and D7, thus completing the geocast message transfer.

As described herein, logicast geographic based logical message addressing and delivery provides the capability to address and deliver logically addressed messages when the logical address includes a geographic constraint. For example, a logicast message could be sent to all TSA employees present in Terminal C of Newark Airport. In this example configuration, the spatial sub-predicate is Terminal C of Newark Airport, and the filter sub-predicate verifies that a receiving device was issued by TSA. In an example embodiment, the filter sub-predicate cryptographically verifies that the receiving device was issued by TSA. For example, the filter sub-predicate could be encrypted with a cryptographic key (or keys), and only devices issued by TSA would have the appropriate cryptographic key to decrypt the encrypted filter sub-predicate. If the encrypted filter sub-predicate is properly decrypted, the message can be accepted and processed by the receiving device. If the encrypted filter sub-predicate is not properly decrypted, the message can be discarded.

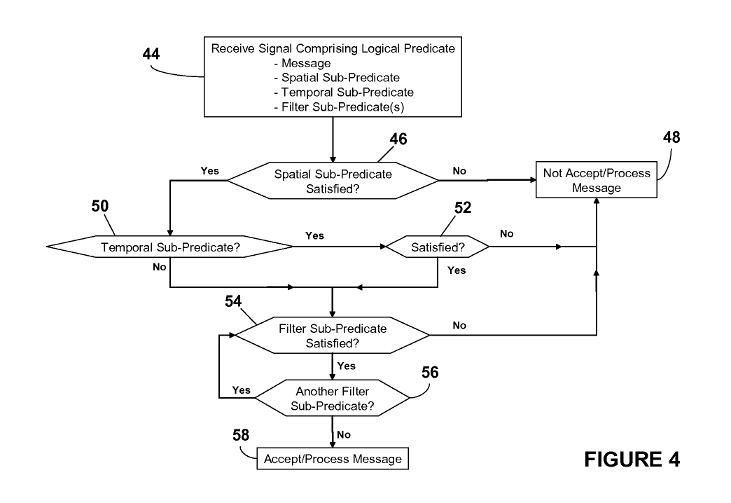

FIG. 4 is a flow diagram of an example process for implementing geographic based logical message addressing and delivery (logicast). A logicast signal is received at step 44. The logicast signal comprises a message and logical predicate. In various example configurations, the logicast signal can comprises separate logical predicate and messages portions, the logical predicate can be incorporated into the message, or any combination thereof. For example, any one or combination of the spatial sub-predicate, temporal sub-predicate, or filter sub-predicate(s) could be included as part of a header of the message portion of the logicast signal.

The logical predicate comprises a spatial sub-predicate, an optional temporal sub-predicate, a filter sub-predicate, or any combination thereof. The logical predicate can comprise one or more filter sub-predicates. The logical predicate can optionally comprise a temporal sub-predicate. The temporal sub-predicate can be indicative of a time, time period, time interval, or the like in which an intended recipient is to be located at a physical location indicated by the spatial sub-predicate.

The physical location can be described in terms of any appropriate shape, location, or the like. For example the physical location can be described as a building or group of buildings (e.g., campus), landmark, institution (e.g., National Institutes of Health, etc.), or the like. The physical location can be described as a geometric shape, such as a rectangle, a circle, a hexagon, an irregular shape, a curvilinear shape, or any combination thereof. The physical location can be in two or three dimensions. For example, the physical location can be a sphere or any appropriate three-dimensional shape. The physical location can be defined in the content of communications among geocast ad hoc network members. Thus, information describing the physical location (e.g., location, size, shape, coordinates, range of coordinates, etc.) can be contained in packets communicated among the geocast ad hoc network members. The information could vary from packet to packet, vary as a function of time (e.g., geographic region changes when mall closes, or around holidays), and or predetermined and fixed prior to communications between the members of the geocast ad hoc network.

At step 46, it is determined if the spatial sub-predicate is satisfied. Determination as to whether the spatial sub-predicate is satisfied can be accomplished by any appropriate device, apparatus, system, or the like. In an example embodiment, the device that received the logicast signal determines if the spatial sub-predicate is satisfied. For example, the receiving device can process the logicast signal to extract the spatial sub-predicate, and determine the physical location indicated by the spatial sub-predicate. The device can compare the device's current physical location with the location indicated by the spatial sub-predicate. The current physical location of the device can be determined in any appropriate manner. For example, a device can determine its own geographical location through any type of location determination system including, for example, the Global Positioning System (GPS), assisted GPS (A-GPS), time difference of arrival calculations, configured constant location (in the case of non-moving nodes), any combination thereof, or any other appropriate means. If it is determined, at step 46, that the spatial sub-predicate is not satisfied, the message is not accepted or processed by the intended recipient at step 48. It is to be understood that the process depicted in FIG. 4 is not necessarily separate from transfer of the message. Thus, in embodiments wherein the logicast message is transferred via a geocast or other geographically-based network protocol, step 46 cay be conducted as part of the execution of that protocol. Logicast processing can rely on geocast processing to get the message to the recipient as well as to decide if the recipient is in the set of specified physical locations.

If it is determined, at step 46, that the spatial sub-predicate is satisfied, it is determined, at step 50, if a temporal sub-predicate was included in the logicast signal. Determination as to whether a temporal spatial sub-predicate was included in the logicast signal can be accomplished by any appropriate device, apparatus, system, or the like. In an example embodiment, the device that received the logicast signal determines if a temporal spatial sub-predicate was included in the logicast signal. If it is determined, at step 50, that a temporal sub-predicate was included in the logicast signal, it is determined, at step 52, if the temporal sub-predicate is satisfied. Determination as to whether the temporal sub-predicate is satisfied can be accomplished by any appropriate device, apparatus, system, or the like. In an example embodiment, the device that received the logicast signal determines if the temporal sub-predicate is satisfied. If it is determined, at step 52, that the temporal sub-predicated is not satisfied, the message is not accepted or process by the intended recipient at step 48.

As described above, the temporal sub-predicate can be indicative of a time, time period, time interval, or the like in which an intended recipient is to be located at a physical location indicated by the spatial sub-predicate. For example, a specific time of day, a window around a time of day, an amount of time to be added to the time the logicast message was received to determine a time window, any number of predetermined times or time windows, or the like. As one example, an advertiser could geocast a coupon, for a particular product, to all recipients located in a store of a competitor. This geocast could include a message (indicating the coupon) using a logicast address having a temporal window that allows for delivery of the message only between, for example, 12 Noon and 4 PM. Thus, the temporal sub-predicate would be indicative of the time period between 12 Noon and 4 PM. The temporal sub-predicate could include a day, or days, of the week. For example, the temporal sub-predicate could include the time period between 12 Noon and 4 PM for each day of the week except Sunday (assuming the competitor is closed on Sunday). As another example, a sender can send a geocast message to particular invitees of a party, wherein the temporal sub-predicate would limit acceptance and processing of the message to the start time of the party, or the like. Thus, the temporal sub-predicate could be indicative of a time interval ending at the time and date of the start of the party. As yet another example of a temporal sub-predicate, emergency responders could send geocast messages having hurricane evacuation instructions. The messages would be deliverable (accepted and processed by a receiving device) only until the end of the hurricane warning time period.

Determination as to whether a temporal sub-predicate is satisfied can be accomplished in any appropriate manner. For example, the device receiving the logicast signal can determine a time based on an internal clock of the device, and compare it to the temporal sub-predicate, a time provided by other than the device receiving the logicast signal (e.g., GPS, external clock, network entity, etc.) can to be used to compare to the temporal sub-predicate.

If it is determined, at step 50, that a temporal sub-predicate was not included in the logicast signal, it is determined, at step 54, if the filter sub-predicate is satisfied. Determination as to whether the filter sub-predicate is satisfied can be accomplished by any appropriate device, apparatus, system, or the like. In an example embodiment, the device that received the logicast signal determines if the filter sub-predicate is satisfied.

A filter sub-predicate can be indicative of any appropriate conditional information. For example, a logicast message could be sent to all active duty soldiers in the 11th Armored Division, located at Fort Irwin, of rank at least Captain, who are not named Smith. The message could be to notify all the intended recipients of a surprise birthday party for General Smith. The spatial sub-predicate would be indicative of Fort Irwin, and the filter sub-predicates would be indicative of the 11^{th} Armored Division, personnel having a rank of Captain or above, persons not named Smith. The message could indicate the notice of the party, the time of the party, the location of the party, RSVP instructions, for example. In various example embodiments, information stored on a receiving device (e.g., user profile, specific, purposely stored information, etc.) can be utilized to determine of filter sub-predicates are satisfied, information stored on a device, apparatus, system, or the like other that the device receiving the logicast message (e.g., queried server and/or database) can be utilized to determine of filter sub-predicates are satisfied, or any appropriate combination thereof.

If it is determined, at step 54, that the filter sub-predicate is not satisfied, the message is not accepted or processed by the intended recipient at step 48. If it is determined, at step 54, that the filter sub-predicate is satisfied, it is determined, at step 56, if another filter sub-predicate was included in the logicast signal. Determination as to whether another filter sub-predicate was included in the logicast signal can be accomplished by any appropriate device, apparatus, system, or the like. In an example embodiment, the device that received the logicast signal determines if another filter sub-predicate was included in the logicast signal. If it is determined, at step 56, that another filter sub-predicate was included in the logicast signal, the process proceeds to step 54 and continues as described above. If it is determined, at step 56, that another filter sub-predicate was included in the logicast message, the process ends at step 58.

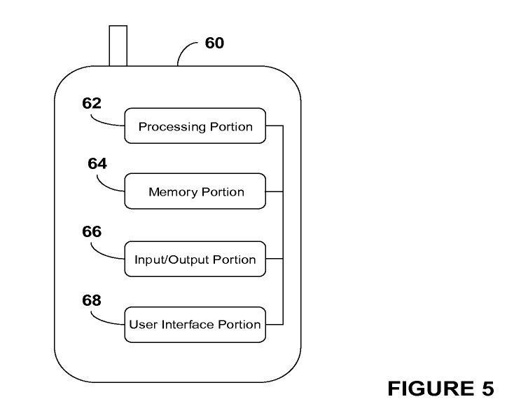

FIG. 5 is a block diagram of an example communications device 60 (node) configured to implement geographic based logical message addressing and delivery (logicast). In an example configuration, communications device 60 is a mobile wireless device. The communications device 60 can comprise any appropriate device, examples of which include a portable computing device, such as a laptop, a personal digital assistant (“PDA”), a portable phone (e.g., a cell phone or the like, a smart phone, a video phone), a portable email device, a portable gaming device, a TV, a DVD player, portable media player, (e.g., a portable music player, such as an MP3 player, a walkmans, etc.), a portable navigation device (e.g., GPS compatible device, A-GPS compatible device, etc.), or a combination thereof. The communications device 60 can include devices that are not typically thought of as portable, such as, for example, a public computing device, a navigation device installed in-vehicle, a set top box, or the like. The mobile communications device 60 can include non-conventional computing devices, such as, for example, a kitchen appliance, a motor vehicle control (e.g., steering wheel), etc., or the like. As evident from the herein description, a communications device is not software per se.

The communications device 60 can include any appropriate device, mechanism, software, and/or hardware for implementing geographic based logical message addressing and delivery as described herein. In an example embodiment, the ability to communicate via geographic based logical message addressing and delivery is a feature of the communications device 60 that can be turned on and off. Thus, an owner of the communications device 60 can opt-in or opt-out of this capability.

In an example configuration, the communications device 60 comprises a processing portion 62, a memory portion 64, an input/output portion 66, and a user interface (UI) portion 68. It is emphasized that the block diagram depiction of communications device 60 is exemplary and not intended to imply a specific implementation and/or configuration. For example, in an example configuration, the communications device 60 comprises a cellular phone and the processing portion 62 and/or the memory portion 64 are implemented, in part or in total, on a subscriber identity module (SIM) of the mobile communications device 60. In another example configuration, the communications device 60 comprises a laptop computer. The laptop computer can include a SIM, and various portions of the processing portion 62 and/or the memory portion 64 can be implemented on the SIM, on the laptop other than the SIM, or any combination thereof.

The processing portion 62, memory portion 64, input/output portion 66, and user interface portion 68 are coupled together to allow communications therebetween. In various embodiments, the input/output portion 66 comprises a receiver of the communications device 60, a transmitter of the communications device 60, or a combination thereof. The input/output portion 66 is capable of receiving and/or providing information pertaining geographic based logical message addressing and delivery as described above. For example, the input/output portion 66 is capable of receiving and/or sending a logicast signal, a logicast message, a logical predicate, a spatial sub-predicate, a temporal sub-predicate, a filter sub-predicate, information pertaining to a physical location/geographic region, or any appropriate combination thereof, or the like, as described herein. In an example embodiment, the input/output portion 66 is capable of receiving and/or sending information to determine a location of the communications device 60. In an example configuration, the input\output portion 66 comprises a GPS receiver. In various configurations, the input/output portion 66 can receive and/or provide information via any appropriate means, such as, for example, optical means (e.g., infrared), electromagnetic means (e.g., RF, WI-FI, BLUETOOTH, ZIGBEE, etc.), acoustic means (e.g., speaker, microphone, ultrasonic receiver, ultrasonic transmitter), or a combination thereof.

The processing portion 62 is capable of performing functions pertaining to geographic based logical message addressing and delivery as described above. For example, the processing portion 62 is capable of analyzing a logicast signal, parsing a logicast signal, determining if a spatial sub-predicate is satisfied, determining of a temporal sub-predicate is satisfied, determining if a temporal sub-predicate is included in a logicast signal, determining if a spatial sub-predicate is included in a logicast signal, determining if a filter sub-predicate is included in a logicast signal, discarding a message, accepting a message, processing a message, determining a location of the communications device 60, or any appropriate combination thereof, or the like, as described above. In various embodiments, the procession portion 62 is configured to determine a location of the communications device 60, a separate portion can be configured to determine location of the communication device 60, or any combination thereof.

In a basic configuration, the communications device 60 can include at least one memory portion 64. The memory potion 64 is a tangible memory portion comprising a tangible physical structure. The memory portion 64 can store any information utilized in conjunction with geographic based logical message addressing and delivery, as described above. For example, the memory portion 64 is capable of storing a logicast message, information pertaining to a logicast message, a spatial sub-predicate, a temporal sub-predicate, a filter sub-predicate, information pertaining to a physical location, information pertaining to accepting a message, processing a message, information pertaining to discarding a message, or any appropriate combination thereof, or the like, as described above. Depending upon the exact configuration and type of processor, the memory portion 64 can be volatile (such as some types of RAM), non-volatile (such as ROM, flash memory, etc.), or a combination thereof. The mobile communications device 60 can include additional tangible storage having a physical tangible structure. Examples of additional tangible storage media include (e.g., removable storage and/or non-removable storage) including tape, flash memory, smart cards, CD-ROM, digital versatile disks (DVD) or other optical storage, magnetic cassettes, magnetic tape, magnetic disk storage or other magnetic storage devices, universal serial bus (USB) compatible memory, or any other medium which can be used to store information and which can be accessed by the mobile communications device 60.

The communications device 60 also can contain a UI portion 68 allowing a user to communicate with the communications device 60. The UI portion 68 is capable of rendering any information utilized in conjunction with geographic based logical message addressing and delivery, as described above. For example, the UI portion 68 can render a message, or the like, as described above. The UI portion 68 can provide the ability to control the communications device 60, via, for example, buttons, soft keys, voice actuated controls, a touch screen, movement of the mobile communications device 60, visual cues (e.g., moving a hand in front of a camera on the mobile communications device 60), or the like. The UI portion 68 can provide visual information (e.g., via a display), audio information (e.g., via speaker), mechanically (e.g., via a vibrating mechanism), or a combination thereof. In various configurations, the UI portion 68 can comprise a display, a touch screen, a keyboard, an accelerometer, a motion detector, a speaker, a microphone, a camera, a tilt sensor, or any combination thereof. The UI portion 68 can comprise means for inputting biometric information, such as, for example, fingerprint information, retinal information, voice information, and/or facial characteristic information.

In an example embodiment, the user interface portion 68, provides the ability for a user of the communications device 60 to generate a logicast address, generate a logicast message, send logicast messages, and receive a logicast message, etc., via various mechanisms. For example, a user could indicate (e.g., draw, encircle, touch, multiple touches, etc.) on a map display the geocast region of a logicast message using his/her finger (or fingers), a pointer, a mouse, or the like, or any appropriate combination thereof. For example, a user could use his/her finger (or fingers) to touch a location, or multiple locations, on a map display; a pointer to touch a location, or multiple locations, on a map display; and/or a mouse to touch a location, or multiple locations, on a map display, or the like, or any appropriate combination thereof. The user could select filter predicates, or filter sub-predicates, elements and values using menus and/or text input fields, or the like.

As described above, in various example configurations, the logicast signal can comprises separate logical predicate and messages portions, the logical predicate can be incorporated into the message, or any combination thereof. In an example embodiment, the filter predicate/sub-predicates is incorporated into the address portion of the logicast message. In this example embodiment, the filter predicate, at least in part, can be incorporated into a header portion of the address of the logicast message. That is, the entire filter predicate could be incorporated into the address of the logicast message, or a portion of the filter predicate could be incorporated into the address of the logicast message, with the other portions of the filter predicate being incorporated into other portions of the logicast signal.

In an example configuration, the filter predicate can comprise a list of sign-keyword-value triples. SKVTs can be separated by spaces, or other appropriated separator. It is to be understood that the herein described SKVT is exemplary only, and not intended to be construed as limiting. Any appropriate indicators can be used.

In this example embodiment, a SKVT comprises:
A sign-keyword-value triple (SKVT) can comprise: a sign indicator, such a plus character “+” and a minus character “−”, or the like. The plus sign indicates logical affirmation and the minus sign indicate logical negation.
a keyword field, comprises alphanumeric characters (non-space, non-colon) ASCII bytes
A colon character “:”
A value field, comprising a sequence of non-space ASCII bytes

For example, the above mentioned filter predicate indicative of the 11^{th} Armored Division, personnel having a rank of Captain or above, persons not named Smith, could be represented by the following SKVT.
+Organization:11th_Armored_Cavalry+MinimumRank:Captain+Retired:False−Name:Smith

As another example, the above mentioned filter predicate indicative of a credential verifying that a receiving device was issued by TSA, could be represented by the following SKVT.
+TSACredential:bh34nap09andsckj1979cae889c8ca98ecxf

In an example embodiment, each SKVT is evaluated. If the result of any SKVT is either FALSE or UNKNOWN, then the filter predicate evaluation result is FALSE. Accordingly, the message could be silently discarded. If the results of all SKVT evaluations are TRUE, then the filter predicate evaluation result is TRUE. And, accordingly, the message is accepted and can be provided, for processing, to any appropriate application, or applications, residing on the receiving device.

In an example embodiment, the keyword field of the SKVT can be looked up in a table of SKVT keywords provided on a receiving device. If the keyword is not found, the SKVT evaluation result can be “UNKNOWN.” If the keyword is found, an evaluation procedure (application) stored on the receiving device, for example, can be retrieved and associated with the keyword. The evaluator procedure can be executed, with the value field string provided as input. The evaluator procedure can return one of {TRUE, FALSE, UNKNOWN} resulting in the SKVT evaluation being, respectively, one of TRUE, FALSE, UNKNOWN.

Many evaluator procedure types and operations are possible. For example, values resident on the receiving device can be compared with the value field string. This type of evaluator is referred to as a lookup evaluator. For example, a USERNAME evaluator would look in the receiving device's “username” attribute as accessible via an API, or the like, and compare the name found with the value field string, returning the appropriate Boolean value (true if they match, false of the do not match or can not be found). A class of lookup evaluators can return a Boolean value, such as the “Retired” evaluator mentioned above. These are useful for matching attributes with simple yes/no values. Other evaluators can implement loose matches, such as the “MinimumRank” evaluator mentioned above. In this case, the “rank” attribute can be looked up in the device via an API call, or the like, and the value retrieved can be located within an ordered list of rank names. It can then be determined whether the value is higher or equal to that of the value field string rank name.

Other evaluators can use cryptographic techniques to implement assurance or privacy of values in the SKVT. For example, if it is desired to be confident that a message is delivered only to members of a particular law enforcement organization (e.g., FBI), an evaluator such as “FBICredential” could be used, which takes the value string, attempts to decrypt it using a secure shared key known only to devices issued to FBI agents, and verifies that the decryption result is correct. Such a value could include the time, or other technique, for ensuring against replay attacks and other attacks on cryptographically secured schemes.

Although not necessary to implement geographic based logical message addressing and delivery (logicast), a communications device can be part of and/or in communications with various wireless communications networks. Some of which are described below.

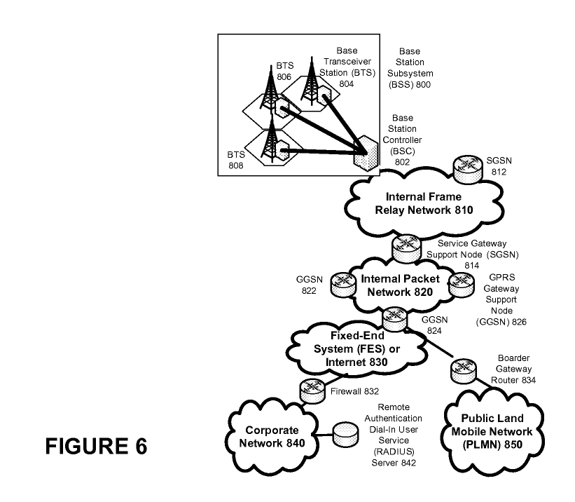

FIG. 6 depicts an overall block diagram of an exemplary packet-based mobile cellular network environment, such as a GPRS network, within which geographic based logical message addressing and delivery can be implemented. In the exemplary packet-based mobile cellular network environment shown in FIG. 6, there are a plurality of Base Station Subsystems (“BSS”) 800 (only one is shown), each of which comprises a Base Station Controller (“BSC”) 802 serving a plurality of Base Transceiver Stations (“BTS”) such as BTSs 804, 806, and 808. BTSs 804, 806, 808, etc. are the access points where users of packet-based mobile devices become connected to the wireless network. In exemplary fashion, the packet traffic originating from user devices is transported via an over-the-air interface to a BTS 808, and from the BTS 808 to the BSC 802. Base station subsystems, such as BSS 800, are a part of internal frame relay network 810 that can include Service GPRS Support Nodes (“SGSN”) such as SGSN 812 and 814. Each SGSN is connected to an internal packet network 820 through which a SGSN 812, 814, etc. can route data packets to and from a plurality of gateway GPRS support nodes (GGSN) 822, 824, 826, etc. As illustrated, SGSN 814 and GGSNs 822, 824, and 826 are part of internal packet network 820. Gateway GPRS serving nodes 822, 824 and 826 mainly provide an interface to external Internet Protocol (“IP”) networks such as Public Land Mobile Network (“PLMN”) 850, corporate intranets 840, or Fixed-End System (“FES”) or the public Internet 830. As illustrated, subscriber corporate network 840 may be connected to GGSN 824 via firewall 832; and PLMN 850 is connected to GGSN 824 via boarder gateway router 834. The Remote Authentication Dial-In User Service (“RADIUS”) server 842 may be used for caller authentication when a user of a mobile cellular device calls corporate network 840.

Generally, there can be a several cell sizes in a GSM network, referred to as macro, micro, pico, femto and umbrella cells. The coverage area of each cell is different in different environments. Macro cells can be regarded as cells in which the base station antenna is installed in a mast or a building above average roof top level. Micro cells are cells whose antenna height is under average roof top level. Micro-cells are typically used in urban areas. Pico cells are small cells having a diameter of a few dozen meters. Pico cells are used mainly indoors. Femto cells have the same size as pico cells, but a smaller transport capacity. Femto cells are used indoors, in residential, or small business environments. On the other hand, umbrella cells are used to cover shadowed regions of smaller cells and fill in gaps in coverage between those cells.

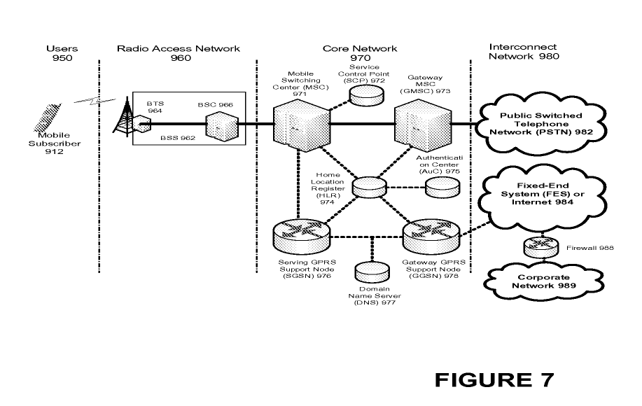

FIG. 7 illustrates an architecture of a typical GPRS network within which geographic based logical message addressing and delivery can be implemented. The architecture depicted in FIG. 7 is segmented into four groups: users 950, radio access network 960, core network 970, and interconnect network 980. Users 950 comprise a plurality of end users. Note, device 912 is referred to as a mobile subscriber in the description of network shown in FIG. 7. In an example embodiment, the device depicted as mobile subscriber 912 comprises a communications device (e.g., communications device 60). Radio access network 960 comprises a plurality of base station subsystems such as BSSs 962, which include BTSs 964 and BSCs 966. Core network 970 comprises a host of various network elements. As illustrated in FIG. 7, core network 970 may comprise Mobile Switching Center (“MSC”) 971, Service Control Point (“SCP”) 972, gateway MSC 973, SGSN 976, Home Location Register (“HLR”) 974, Authentication Center (“AuC”) 975, Domain Name Server (“DNS”) 977, and GGSN 978. Interconnect network 980 also comprises a host of various networks and other network elements. As illustrated in FIG. 7, interconnect network 980 comprises Public Switched Telephone Network (“PSTN”) 982, Fixed-End System (“FES”) or Internet 984, firewall 988, and Corporate Network 989.

A mobile switching center can be connected to a large number of base station controllers. At MSC 971, for instance, depending on the type of traffic, the traffic may be separated in that voice may be sent to Public Switched Telephone Network (“PSTN”) 982 through Gateway MSC (“GMSC”) 973, and/or data may be sent to SGSN 976, which then sends the data traffic to GGSN 978 for further forwarding.

When MSC 971 receives call traffic, for example, from BSC 966, it sends a query to a database hosted by SCP 972. The SCP 972 processes the request and issues a response to MSC 971 so that it may continue call processing as appropriate.

The HLR 974 is a centralized database for users to register to the GPRS network. HLR 974 stores static information about the subscribers such as the International Mobile Subscriber Identity (“IMSI”), subscribed services, and a key for authenticating the subscriber. HLR 974 also stores dynamic subscriber information such as the current location of the mobile subscriber. Associated with HLR 974 is AuC 975. AuC 975 is a database that contains the algorithms for authenticating subscribers and includes the associated keys for encryption to safeguard the user input for authentication.

In the following, depending on context, the term “mobile subscriber” sometimes refers to the end user and sometimes to the actual portable device, such as a mobile device, used by an end user of the mobile cellular service. When a mobile subscriber turns on his or her mobile device, the mobile device goes through an attach process by which the mobile device attaches to an SGSN of the GPRS network. In FIG. 7, when mobile subscriber 912 initiates the attach process by turning on the network capabilities of the mobile device, an attach request is sent by mobile subscriber 912 to SGSN 976. The SGSN 976 queries another SGSN, to which mobile subscriber 912 was attached before, for the identity of mobile subscriber 912. Upon receiving the identity of mobile subscriber 912 from the other SGSN, SGSN 976 requests more information from mobile subscriber 912. This information is used to authenticate mobile subscriber 912 to SGSN 976 by HLR 974. Once verified, SGSN 976 sends a location update to HLR 974 indicating the change of location to a new SGSN, in this case SGSN 976. HLR 974 notifies the old SGSN, to which mobile subscriber 912 was attached before, to cancel the location process for mobile subscriber 912. HLR 974 then notifies SGSN 976 that the location update has been performed. At this time, SGSN 976 sends an Attach Accept message to mobile subscriber 912, which in turn sends an Attach Complete message to SGSN 976.

After attaching itself with the network, mobile subscriber 912 then goes through the authentication process. In the authentication process, SGSN 976 sends the authentication information to HLR 974, which sends information back to SGSN 976 based on the user profile that was part of the user's initial setup. The SGSN 976 then sends a request for authentication and ciphering to mobile subscriber 912. The mobile subscriber 912 uses an algorithm to send the user identification (ID) and password to SGSN 976. The SGSN 976 uses the same algorithm and compares the result. If a match occurs, SGSN 976 authenticates mobile subscriber 912.

Next, the mobile subscriber 912 establishes a user session with the destination network, corporate network 989, by going through a Packet Data Protocol (“PDP”) activation process. Briefly, in the process, mobile subscriber 912 requests access to the Access Point Name (“APN”), for example, UPS.com, and SGSN 976 receives the activation request from mobile subscriber 912. SGSN 976 then initiates a Domain Name Service (“DNS”) query to learn which GGSN node has access to the UPS.com APN. The DNS query is sent to the DNS server within the core network 970, such as DNS 977, which is provisioned to map to one or more GGSN nodes in the core network 970. Based on the APN, the mapped GGSN 978 can access the requested corporate network 989. The SGSN 976 then sends to GGSN 978 a Create Packet Data Protocol (“PDP”) Context Request message that contains necessary information. The GGSN 978 sends a Create PDP Context Response message to SGSN 976, which then sends an Activate PDP Context Accept message to mobile subscriber 912.

Once activated, data packets of the call made by mobile subscriber 912 can then go through radio access network 960, core network 970, and interconnect network 980, in a particular fixed-end system or Internet 984 and firewall 988, to reach corporate network 989.

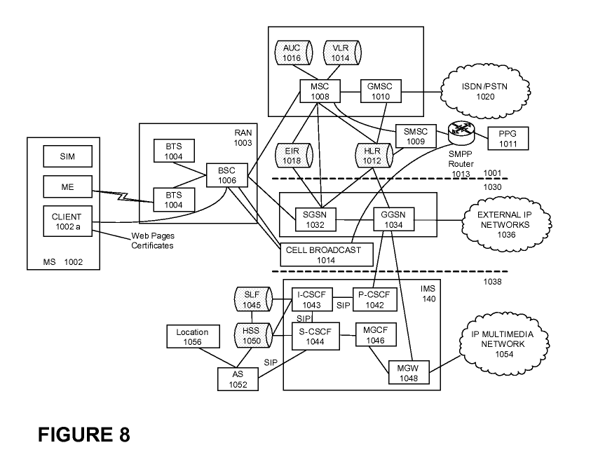

FIG. 8 illustrates an exemplary block diagram view of a GSM/GPRS/IP multimedia network architecture within geographic based logical message addressing and delivery can be implemented. As illustrated, the architecture of FIG. 8 includes a GSM core network 1001, a GPRS network 1030 and an IP multimedia network 1038. The GSM core network 1001 includes a Mobile Station (MS) 1002, at least one Base Transceiver Station (BTS) 1004 and a Base Station Controller (BSC) 1006. The MS 1002 is physical equipment or Mobile Equipment (ME), such as a mobile phone or a laptop computer that is used by mobile subscribers, with a Subscriber identity Module (SIM) or a Universal Integrated Circuit Card (UICC). The SIM or UICC includes an International Mobile Subscriber Identity (IMSI), which is a unique identifier of a subscriber. The BTS 1004 is physical equipment, such as a radio tower, that enables a radio interface to communicate with the MS. Each BTS may serve more than one MS. The BSC 1006 manages radio resources, including the BTS. The BSC may be connected to several BTSs. The BSC and BTS components, in combination, are generally referred to as a base station (BSS) or radio access network (RAN) 1003.

The GSM core network 1001 also includes a Mobile Switching Center (MSC) 1008, a Gateway Mobile Switching Center (GMSC) 1010, a Home Location Register (HLR) 1012, Visitor Location Register (VLR) 1014, an Authentication Center (AuC) 1018, and an Equipment Identity Register (EIR) 1016. The MSC 1008 performs a switching function for the network. The MSC also performs other functions, such as registration, authentication, location updating, handovers, and call routing. The GMSC 1010 provides a gateway between the GSM network and other networks, such as an Integrated Services Digital Network (ISDN) or Public Switched Telephone Networks (PSTNs) 1020. Thus, the GMSC 1010 provides interworking functionality with external networks.

The HLR 1012 is a database that contains administrative information regarding each subscriber registered in a corresponding GSM network. The HLR 1012 also contains the current location of each MS. The VLR 1014 is a database that contains selected administrative information from the HLR 1012. The VLR contains information necessary for call control and provision of subscribed services for each MS currently located in a geographical area controlled by the VLR. The HLR 1012 and the VLR 1014, together with the MSC 1008, provide the call routing and roaming capabilities of GSM. The AuC 1016 provides the parameters needed for authentication and encryption functions. Such parameters allow verification of a subscriber's identity. The EIR 1018 stores security-sensitive information about the mobile equipment.

A Short Message Service Center (SMSC) 1009 allows one-to-one Short Message Service (SMS) messages to be sent to/from the MS 1002. A Push Proxy Gateway (PPG) 1011 is used to “push” (i.e., send without a synchronous request) content to the MS 1002. The PPG 1011 acts as a proxy between wired and wireless networks to facilitate pushing of data to the MS 1002. A Short Message Peer to Peer (SMPP) protocol router 1013 is provided to convert SMS-based SMPP messages to cell broadcast messages. SMPP is a protocol for exchanging SMS messages between SMS peer entities such as short message service centers. The SMPP protocol is often used to allow third parties, e.g., content suppliers such as news organizations, to submit bulk messages.

To gain access to GSM services, such as speech, data, and short message service (SMS), the MS first registers with the network to indicate its current location by performing a location update and IMSI attach procedure. The MS 1002 sends a location update including its current location information to the MSC/VLR, via the BTS 1004 and the BSC 1006. The location information is then sent to the MS's HLR. The HLR is updated with the location information received from the MSC/VLR. The location update also is performed when the MS moves to a new location area. Typically, the location update is periodically performed to update the database as location updating events occur.

The GPRS network 1030 is logically implemented on the GSM core network architecture by introducing two packet-switching network nodes, a serving GPRS support node (SGSN) 1032, a cell broadcast and a Gateway GPRS support node (GGSN) 1034. The SGSN 1032 is at the same hierarchical level as the MSC 1008 in the GSM network. The SGSN controls the connection between the GPRS network and the MS 1002. The SGSN also keeps track of individual MS's locations and security functions and access controls.

A Cell Broadcast Center (CBC) 1014 communicates cell broadcast messages that are typically delivered to multiple users in a specified area. Cell Broadcast is one-to-many geographically focused service. It enables messages to be communicated to multiple mobile phone customers who are located within a given part of its network coverage area at the time the message is broadcast.

The GGSN 1034 provides a gateway between the GPRS network and a public packet network (PDN) or other IP networks 1036. That is, the GGSN provides interworking functionality with external networks, and sets up a logical link to the MS through the SGSN. When packet-switched data leaves the GPRS network, it is transferred to an external TCP-IP network 1036, such as an X.25. network or the Internet. In order to access GPRS services, the MS first attaches itself to the GPRS network by performing an attach procedure. The MS then activates a packet data protocol (PDP) context, thus activating a packet communication session between the MS, the SGSN, and the GGSN.

In a GSM/GPRS network, GPRS services and GSM services can be used in parallel. The MS can operate in one of three classes: class A, class B, and class C. A class A MS can attach to the network for both GPRS services and GSM services simultaneously. A class A MS also supports simultaneous operation of GPRS services and GSM services. For example, class A mobiles can receive GSM voice/data/SMS calls and GPRS data calls at the same time.

A class B MS can attach to the network for both GPRS services and GSM services simultaneously. However, a class B MS does not support simultaneous operation of the GPRS services and GSM services. That is, a class B MS can only use one of the two services at a given time.

A class C MS can attach for only one of the GPRS services and GSM services at a time. Simultaneous attachment and operation of GPRS services and GSM services is not possible with a class C MS.

A GPRS network 1030 can be designed to operate in three network operation modes (NOM1, NOM2 and NOM3). A network operation mode of a GPRS network is indicated by a parameter in system information messages transmitted within a cell. The system information messages dictates a MS where to listen for paging messages and how to signal towards the network. The network operation mode represents the capabilities of the GPRS network. In a NOM1 network, a MS can receive pages from a circuit switched domain (voice call) when engaged in a data call. The MS can suspend the data call or take both simultaneously, depending on the ability of the MS. In a NOM2 network, a MS may not received pages from a circuit switched domain when engaged in a data call, since the MS is receiving data and is not listening to a paging channel. In a NOM3 network, a MS can monitor pages for a circuit switched network while received data and vise versa.

The IP multimedia network 1038 was introduced with 3GPP Release 5, and includes an IP multimedia subsystem (IMS) 1040 to provide rich multimedia services to end users. A representative set of the network entities within the IMS 1040 are a call/session control function (CSCF), a media gateway control function (MGCF) 1046, a media gateway (MGW) 1048, and a master subscriber database, called a home subscriber server (HSS) 1050. The HSS 1050 may be common to the GSM network 1001, the GPRS network 1030 as well as the IP multimedia network 1038.

The IP multimedia system 1040 is built around the call/session control function, of which there are three types: an interrogating CSCF (I-CSCF) 1043, a proxy CSCF (P-CSCF) 1042, and a serving CSCF (S-CSCF) 1044. The P-CSCF 1042 is the MS's first point of contact with the IMS 1040. The P-CSCF 1042 forwards session initiation protocol (SIP) messages received from the MS to an SIP server in a home network (and vice versa) of the MS. The P-CSCF 1042 may also modify an outgoing request according to a set of rules defined by the network operator (for example, address analysis and potential modification).

The I-CSCF 1043, forms an entrance to a home network and hides the inner topology of the home network from other networks and provides flexibility for selecting an S-CSCF. The I-CSCF 1043 may contact a subscriber location function (SLF) 1045 to determine which HSS 1050 to use for the particular subscriber, if multiple HSS's 1050 are present. The S-CSCF 1044 performs the session control services for the MS 1002. This includes routing originating sessions to external networks and routing terminating sessions to visited networks. The S-CSCF 1044 also decides whether an application server (AS) 1052 is required to receive information on an incoming SIP session request to ensure appropriate service handling. This decision is based on information received from the HSS 1050 (or other sources, such as an application server 1052). The AS 1052 also communicates to a location server 1056 (e.g., a Gateway Mobile Location Center (GMLC)) that provides a position (e.g., latitude/longitude coordinates) of the MS 1002.

The HSS 1050 contains a subscriber profile and keeps track of which core network node is currently handling the subscriber. It also supports subscriber authentication and authorization functions (AAA). In networks with more than one HSS 1050, a subscriber location function provides information on the HSS 1050 that contains the profile of a given subscriber.

The MGCF 1046 provides interworking functionality between SIP session control signaling from the IMS 1040 and ISUP/BICC call control signaling from the external GSTN networks (not shown). It also controls the media gateway (MGW) 1048 that provides user-plane interworking functionality (e.g., converting between AMR- and PCM-coded voice). The MGW 1048 also communicates with other IP multimedia networks 1054.

Push to Talk over Cellular (PoC) capable mobile phones register with the wireless network when the phones are in a predefined area (e.g., job site, etc.). When the mobile phones leave the area, they register with the network in their new location as being outside the predefined area. This registration, however, does not indicate the actual physical location of the mobile phones outside the pre-defined area.

While example embodiments of geographic based logical message addressing and delivery have been described in connection with various computing devices/processors, the underlying concepts can be applied to any computing device, processor, or system capable of implementing geographic based logical message addressing and delivery. The various techniques described herein can be implemented in connection with hardware or software or, where appropriate, with a combination of both. Thus, the methods and apparatuses of geographic based logical message addressing and delivery can be implemented, or certain aspects or portions thereof, can take the form of program code (i.e., instructions) embodied in tangible storage media having a tangible physical structure. Examples of tangible storage media include floppy diskettes, CD-ROMs, DVDs, hard drives, or any other tangible machine-readable storage medium (tangible computer-readable storage medium). When the program code is loaded into and executed by a machine, such as a computer, the machine becomes an apparatus for implementing geographic based logical message addressing and delivery. In the case of program code execution on programmable computers, the computing device will generally include a processor, a storage medium readable by the processor (including volatile and non-volatile memory and/or storage elements), at least one input device, and at least one output device. The program(s) can be implemented in assembly or machine language, if desired. The language can be a compiled or interpreted language, and combined with hardware implementations. As evident from the herein description, a tangible storage medium is to be construed to be statutory subject matter under United States Code, Title 35, Section 101 (35 U.S.C. §101).

The methods and apparatuses for geographic based logical message addressing and delivery also can be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, or the like, the machine becomes an apparatus for implementing a secure mobile ad hoc network. When implemented on a general-purpose processor, the program code combines with the processor to provide a unique apparatus that operates to invoke the functionality of geographic based logical message addressing and delivery.

While geographic based logical message addressing and delivery has been described in connection with the various embodiments of the various figures, it is to be understood that other similar embodiments can be used or modifications and additions can be made to the described embodiments for geographic based logical message addressing and delivery without deviating therefrom. For example, one skilled in the art will recognize that geographic based logical message addressing and delivery as described in the present application may apply to any environment, whether wired or wireless, and may be applied to any number of such devices connected via a communications network and interacting across the network. Therefore, geographic based logical message addressing and delivery should not be limited to any single embodiment, but rather should be construed in breadth and scope in accordance with the appended claims.

What is claimed:

1. A method comprising:
receiving a signal comprising:
an indication of a first logical predicate indicative of a physical location of intended reception of the signal; and
an indication of a second logical predicate to be satisfied by an intended recipient located within the physical location;
processing, by a recipient of the signal, one of the first logical predicate or the second logical predicate, to determine if the one of the first logical predicate or the second logical predicate is satisfied;
when it is determined that the one of the first logical predicate or the second logical predicate is satisfied, processing, by the recipient of the signal, the other of the first logical predicate or the second logical predicate, to determine if the other of the first logical predicate or the second logical predicate is satisfied; and
when it is determined that the first logical predicate is satisfied and the second logical predicate is satisfied, processing, by the recipient of the signal, a message contained in the signal.

2. The method of claim 1, further comprising:
when at least one of the first logical predicate or the second logical predicate is not satisfied, not processing the message.

3. The method of claim 1, wherein the first logical predicate is further indicative of a temporal sub-predicate.

4. The method of claim 1, wherein the signal is formatted as a packet comprising the indication of the physical location as a geographic location.

5. The method of claim 1, further comprising transferring the signal via a geocast protocol.

6. The method in accordance with claim 5, further comprising, when it is determined to transfer the signal, transferring the signal in accordance the location at which the signal was received.

7. The method in accordance with claim 5, further comprising:
when it is determined to transfer the signal:
determining whether the same signal was receive at least a predetermined number of times; and
when it is determined that the signal has not been received the predetermined number of times, transferring the signal.

8. The method in accordance with claim 5, further comprising:
when it is determined to transfer the signal:
determining whether the signal was sent from a location closer than a predetermined minimum distance from the location of receipt of the signal; and
when it is determined that the signal was not sent from a location closer than the predetermined minimum distance from the location of receipt of the signal, transferring the signal.

9. The method in accordance with claim 5, further comprising:
when it is determined to transfer the signal:
determining whether the location of receipt of the signal is closer to a center of the physical location than the location from which the signal was sent; and
when it is determined that the location of receipt of the signal is closer to a center of the physical location than the location from which the signal was sent, transferring the signal.

10. A communications device comprising:
an input/output portion configured to:
receive a signal comprising:
an indication of a first logical predicate indicative of a location of a physical location of intended reception of the signal; and
an indication of a second logical predicate to be satisfied by an intended recipient located within the physical location;
a processing portion configured to:
process one of the first logical predicate or the second logical predicate, to determine if the one of the first logical predicate or the second logical predicate is satisfied;
when it is determined that the one of the first logical predicate or the second logical predicate is satisfied, process the other of the first logical predicate or the second logical predicate, to determine if the other of the first logical predicate or the second logical predicate is satisfied; and
when it is determined that the first logical predicate is satisfied and the second logical predicate is satisfied, process a message contained in the signal.

11. The device of claim 10, the processing portion further configured to:
when at least one of the first logical predicate or the second logical predicate is not satisfied, not process the message.

12. The device of claim 10, wherein the first logical predicate is further indicative of a temporal sub-predicate.

13. The device of claim 10, wherein the signal is formatted as a packet comprising the indication of the physical location as a geographic location.

14. The device of claim 10, the processing portion further configured to transfer the signal via a geocast protocol.

15. The device of claim 14, wherein, when it is determined to transfer the signal, the input/output portion transfers the signal in accordance with the location at which the signal was received.

16. The device of claim 14, wherein:
when it is determined to transfer the signal, the processing portion determines whether the same signal was receive at least a predetermined number of times; and
when it is determined that the signal has not been received the predetermined number of times, the input/output portion transfers the signal.

17. The device of claim 14, wherein:
when it is determined to transfer the signal, the processing portion determines whether the signal was sent from a location closer than a predetermined minimum distance from the location of receipt of the signal; and
when it is determined that the signal was not sent from a location closer than the predetermined minimum distance from the location of receipt of the signal, the input/output portions transfers the signal.

18. The device of claim 14, wherein:
when it is determined to transfer the signal, the processing portion determines whether the location of receipt of the signal is closer to a center of the physical location than the location from which the signal was sent; and
when it is determined that the location of receipt of the signal is closer to a center of the physical location than the location from which the signal was sent, the input/output portions transfers the signal.

19. A computer-readable storage medium having a tangible physical structure, the medium comprising computer-executable instructions stored thereon that when executed cause the computer to:
receive a signal comprising:
an indication of a first logical predicate indicative of a physical location of intended reception of the signal; and
an indication of a second logical predicate to be satisfied by an intended recipient located within the physical location;
process, by a recipient of the signal, one of the first logical predicate or the second logical predicate, to determine if the one of the first logical predicate or the second logical predicate is satisfied;
when it is determined that the one of the first logical predicate or the second logical predicate is satisfied, process, by the recipient of the signal, the other of the first logical predicate or the second logical predicate, to determine if the other of the first logical predicate or the second logical predicate is satisfied;
when it is determined that the first logical predicate is satisfied and the second logical predicate is satisfied, process, by the recipient of the signal, a message contained in the signal; and
when at least one of the first logical predicate or the second logical predicate is not satisfied, not process the message.

20. The medium of claim 19, further comprising transferring the signal via a geocast protocol, wherein:
when it is determined to transfer the signal, transferring the signal in accordance the location at which the signal was received;
when it is determined to transfer the signal, determining whether the same signal was receive at least a predetermined number of times; and when it is determined that the signal has not been received the predetermined number of times, transferring the signal;
when it is determined to transfer the signal, determining whether the signal was sent from a location closer than a predetermined minimum distance from the location of receipt of the signal; and when it is determined that the signal was not sent from a location closer than the predetermined minimum distance from the location of receipt of the signal, transferring the signal; or
when it is determined to transfer the signal, determining whether the location of receipt of the signal is closer to a center of the physical location than the location from which the signal was sent; and when it is determined that the location of receipt of the signal is closer to a center of the physical location than the location from which the signal was sent, transferring the signal.
